(19) United States
(12) Patent Application Publication
(10) Pub. No.: US 2005/0172896 A1
(43) Pub. Date: Aug. 11, 2005

(54) Injector for plasma mass filter

(76) Inventor: Tihiro Ohkawa, La Jolla, CA (US)

Correspondence Address: Neil K. Nydegger, Esq.;NYDEGGER & ASSOCIATES, 348 Olive Street, San Diego, CA, 92103, US

(21) Appl. No.: 10/775,511

(22) Filed: Feb. 10, 2004

(51) Int. Cl. B01D 17/06

(52) U.S. Cl. 118/715; 210/748

(57) ABSTRACT

An injection system for introducing feed material into a plasma mass filter includes an injector for producing a jet of feed material. For a plasma mass filter having a cylindrical wall that surrounds a plasma chamber, the injector is mounted to the outside of wall and oriented to deliver a feed jet into the plasma chamber. Specifically, the injector is oriented to deliver a jet that is directed toward a target volume in the chamber that is located substantially on the longitudinal axis defined by the cylindrical wall. More specifically, the feed material is injected into the chamber to the target volume along a path that is transverse to the direction of plasma rotation in the chamber. A vaporization energy source can be included to generate and direct an energy beam toward the target volume to vaporize the jet of feed material as the jet arrives at the target volume.

### FIELD OF THE INVENTION

The present invention pertains generally to systems and methods for introducing a feed material into a plasma and thereafter converting the feed material into plasma by evaporating and ionizing the feed material. More particularly, the present invention pertains to systems for radially injecting a feed material into a rotating plasma for subsequent conversion of the feed material to plasma. The present invention is particularly, but not exclusively, useful for continuously injecting a multi-constituent feed material into a plasma mass filter to allow for the subsequent separation of the feed material into its constituents.

### BACKGROUND OF THE INVENTION

A fundamental step in any plasma processing operation is the conversion of a feed material into a plasma. For plasma separation processes wherein charged particles in the plasma are to be separated according to their respective mass to charge ratios, it is generally desirable to continuously introduce the material requiring separation into the separator. One way to achieve this is to convert the feed material to a vapor and then introduce the vapor into a vessel for ionization and subsequent separation. For this purpose, a plasma torch can be used to convert the feed material into a vapor.

One example of a device and method for accomplishing a plasma separation process is disclosed and claimed in U.S. Pat. No. 6,096,220, which issued on Aug. 1, 2000 to Ohkawa, for an invention entitled “Plasma Mass Filter” and which is assigned to the same assignee as the present invention. Specifically, Ohkawa '220 discloses a device which relies on the different, predictable, orbital motions of charged particles in crossed electric and magnetic fields in a plasma chamber to separate the charged particles from each other. In the filter disclosed in Ohkawa '220, a multi-species plasma is introduced into one end of a cylindrical chamber for interaction with crossed electric and magnetic fields. As further disclosed in Ohkawa '220, the fields can be configured to cause ions having relatively high mass to charge ratios to be placed on unconfined orbits. These ions are directed toward the cylindrical wall for collection. On the other hand, ions having relatively low mass to charge ratios are placed on confined orbits inside the chamber. These ions transit through the chamber toward the ends of the chamber. It can happen, however, that some low-mass ions, as they undergo separation, are directed toward the end where the multi-species plasma is being introduced into the chamber. This allows the low-mass ions to be re-mixed with multi-species plasma, lowering the separation efficiency of the plasma mass filter.

One way to overcome the end loss described above is to use a tandem plasma mass filter such as the filter disclosed in U.S. Pat. No. 6,235,202, which issued on May 22, 2001 to Ohkawa, for an invention entitled “Tandem Plasma Mass Filter” and which is assigned to the same assignee as the present invention. In Ohkawa '202 a device is disclosed that is somewhat similar to the device disclosed in Ohkawa '220, but allows for the introduction of feed material into a cylindrical plasma chamber midway between the ends of a cylindrical plasma chamber. After separation in the plasma chamber, the heavy ions are still collected on the chamber wall. The light ions, however, are collected at both ends of the cylindrical chamber.

In more detail, the tandem plasma mass filter disclosed in Ohkawa '202 includes a cylindrical wall that surrounds a plasma chamber and is centered about a longitudinal axis. During operation, plasma in the chamber rotates azimuthally about the longitudinal axis due to crossed electric and magnetic fields in the chamber. Specifically, the magnetic field is axially oriented and the electric field is radially oriented. As indicated above, it is contemplated for the tandem filter that feed material be radially introduced into the chamber at a point midway between the ends of the chamber. As such, the feed material is introduced into the chamber in a direction that is normal to the magnetic field lines. This condition generally prohibits introduction of the feed material in an ionized state because the ions will not readily cross the magnetic field lines. Further complicating matters is the fact that the rotating plasma acts to centrifuge non-ionized matter into the wall of the chamber.

With this in mind, the present invention contemplates injecting a jet of fluidic feed material into the plasma chamber along a path that is transverse to the rotating plasma from the wall to a target volume near the center of the plasma chamber. At the target volume, the feed material is vaporized, and the resultant vapors are dissociated and ionized to create a multi-species plasma from the feed material.

There are two physical processes that cause potentially conflicting requirements on the choice of fluid jet parameters. They are the evaporation process and the deflection of the jet by the rotating plasma. The jet should reach the desired deposition region without being centrifuged out of the volume, so the evaporation of the jet in the plasma volume must be taken into account to determine the reduction in plasma radius over the transit to the target region. The parameters to be chosen are the jet radius and the jet velocity.

The jet receives the power per unit area, P, either from the plasma alone or in combination with an external power source. The liquid evaporates from the surface with the molecular flux per unit area, Γ. The heat of evaporation of the liquid is H per molecule and:
Γ=P/H. [1]
Assuming the jet is formed from spherical droplets, the radius of the droplet, r, decreases in the direction of the jet as:

$$( {n}_{0} {v}_{0} ) \frac{ⅆ}{ⅆ x} ( \frac{4}{3} π {r}^{3} ) = - 4 π {r}^{2} Γ \qquad [ 2 ]$$

where n₀ is the liquid molecular density, v₀ is the jet velocity and x is in the direction of the jet. Thus:
dr/dx =−Γ/[n₀ v₀]. [3]
Another concern is the expulsion of the droplets from the plasma by interaction with the rotating plasma before they can be vaporized. The plasma is rotating at the angular frequency ω. The equations of motion are given by:
dv_{R}/dt=v_{θ}²/R [4]
m[d/dt]R v_{θ}=M R πr² n[ωR−v_{θ}]² [5]
where v_{R} is the radial velocity of the droplet, v_{θ} is the droplet velocity in the direction of plasma rotation, R is the radial position of the droplet, n is the plasma density, m is the mass of the droplet, M is the average mass of the plasma ions, r is the radius of the droplet and ω is the angular frequency of the plasma rotation. By using:
m=[4π/3]r³ M′ n₀ [6]
where M′ is the average molecular mass of the liquid and no is the number density of the molecules, the following relationship can be obtained:
dv_{θ}/d t≈[¾] [M/M′] [n/n₀] [ωR−v_{θ}]²/r. [7]
The evaporation rate is given by:
dr/dt=−P/H n₀ [8]
and the equation:
r=r₀[1−t/τᵥ ] [9]
can be obtained where τᵥ=r₀ n₀ H/P.
Substituting Eq [9] into Eq [7]:
v_{θ}=ωR[1−{1−αln[1−t/τᵥ]}⁻¹] [10]
with:
α=[¾] [M/M′][ω R n H/P]. [11]
By assuming t<<τᵥ:
v_{θ}˜ω R α t/τᵥ [12]
and from Eq. [4]:
d²R/dt²˜ω² R α² t²/τᵥ². [13]
The time for escape τₛ is given by:
τₛ˜[τᵥ/ω α]^{1/2}. [14]
The condition that the droplet evaporates before it escapes is given by:
τₛ>>τᵥ
or
ω α τᵥ<21 1. [15]
In terms of the droplet size, the above condition becomes:
r₀<<[4/3][M′/M][P/H]²[ω² R n n₀]⁻¹. [16]
For water droplets with P=10⁶ W/m², H=0.44 eV, ω=10⁴/s. M′/M=1, R=0.4 m, n=10¹⁹ m⁻³ and n₀=3.3×10²⁸ m⁻³ the above condition is:
r₀<<2×10⁻⁵ m.
Accordingly, water droplets with the sizes less than the above value will evaporate before leaving the plasma region.

If a shower head having N nozzles or holes with a diameter of 10⁻⁵ m is used, the total atomic throughput Y is given by:
Y=3 N π r₀² n₀ v. [17]
With the above example parameters, for a water jet with v₀=1 m/s:
Y=N×1.1×10²¹/s.
Thus, the typical throughput for one nozzle is only about 0.001 mol/s.

To support larger throughputs, a larger nozzle can be used with vaporization aided by laser or microwave irradiation. In this case, the fluid droplet radii and velocity are chosen to provide the desired throughput and minimize the deflection. Alternatively, as disclosed herein, vaporization can be aided by breaking droplets into smaller droplets using vibrational energy.

In light of the above, it is an object of the present invention to provide systems and methods for efficiently injecting a feed material into a rotating plasma for subsequent conversion of the feed material to plasma. It is another object of the present invention to provide systems and methods for injecting a feed material to a target volume near the center of a rotating plasma while minimizing loss of the feed material due to centrifugal effects from the rotating plasma. It is yet another object of the present invention to provide systems and methods for injecting a jet of feed material to a target volume near the center of a rotating plasma that minimizes deflection of the jet by the rotating plasma. It is still another object of the present invention to provide systems and methods for injecting a feed material into a plasma to a target volume for vaporization that allows for the subsequent dissociation and ionization of the resulting vapor by the plasma before a significant amount of the vapor is lost from the plasma. Yet another object of the present invention is to provide systems and methods for continuously injecting a multi-constituent feed material into a plasma mass filter and converting the feed material into a multi-species plasma to allow for the subsequent separation of plasma ions according to ion mass. It is still another object of the present invention to provide energy efficient and cost effective systems and methods for injecting a feed material into a rotating plasma to convert the feed material into a plasma.

### SUMMARY OF THE INVENTION

The present invention is directed to an injection system for continuously introducing feed material into a plasma mass filter. After introduction into the plasma mass filter, the feed material is first vaporized and the resulting vapors are subsequently dissociated and ionized to create a multi-species plasma. Next, crossed electric and magnetic fields in the filter interact with the ions of the multi-species plasma to separate the ions according to their mass to charge ratio.

For the present invention, the plasma mass filter includes a cylindrical wall that surrounds a plasma chamber and is centered about a longitudinal axis. The plasma chamber is provided to contain a plasma having a substantially azimuthal rotation about the longitudinal axis. The present invention further includes an injector that is mounted to the outside of the wall and oriented to deliver a fluid jet of feed material into the chamber. Specifically, the injector is oriented to deliver a jet that is directed toward a target volume within the plasma chamber. As explained further below, the target volume is preferably located substantially on the longitudinal axis. In greater detail, the feed material is injected into the chamber along a path that is transverse to the rotating plasma from the wall to the target volume.

It is intended for the present invention that the injector be configured to produce a fluid jet having a predetermined velocity and radius. In accordance with the mathematics outlined above, the velocity and radius of the fluid jet are selected and controlled to create a fluid jet that can pass through the rotating plasma with minimal evaporation of the feed material during transit through the rotating plasma. This allows most of the vaporization to occur at the target volume rather than near the wall of the filter where evaporation would result in a loss of feed material from the plasma. Additionally, the velocity and radius of the fluid droplets are selected and controlled to minimize deflection of the feed material by the rotating plasma. By minimizing the deflection of the droplets in this manner, the droplets can consistently reach the target volume, regardless of fluctuations in the rotational speed and density of the plasma. It is to be appreciated that several factors will influence the selection of the velocity and radius of the fluid jet droplets to minimize transit vaporization and deflection. These include the characteristics of the feed material, the density and rotational speed of the plasma, and the size of the plasma chamber.

The present invention can further include a laser or microwave source for generating a beam directed toward the target volume. With this combined system, the droplets of feed material are continuously vaporized by the energy of the beam as the jet of feed material arrives at the target volume. Because the target volume is located on the longitudinal axis rather than near the wall, vapors generated at the target volume will be dissociated and ionized by the rotating plasma before a significant amount of the vapor is lost from the plasma.

In operation, a multi-constituent material requiring separation is first dissolved in a solvent such as water, sodium hydroxide or a combination thereof to produce a fluidic feed material. For the present invention, it is contemplated that the multi-constituent material may include metal oxides, metal nitrates or a combination thereof. Next, a rotating plasma is first initiated in the chamber, for example, using a carrier gas. With the rotating plasma established, the beam source and injector are simultaneously activated. This activation results in a continuous jet of feed material being directed to the target volume. Upon arrival at the target volume, the jet of feed material is irradiated by the beam resulting in the vaporization of the feed material.

Upon vaporization, the feed material vapor is dissociated and ionized in the rotating plasma producing a multi-species plasma from the feed material. Next, the ions in the multi-species plasma interact with crossed electric and magnetic fields to separate the ions according to their mass to charge ratio. Specifically, ions having a relatively high mass to charge ratio are placed on large orbit trajectories, and accordingly, are directed towards the wall of the filter for collection. On the other hand, ions having a relatively low mass to charge ratio are placed on small orbit trajectories. Thus, the low-mass ions are confined within the chamber and drift towards one of the ends of the cylindrical wall for collection.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an injection system in accordance with the present invention shown for use in conjunction with a tandem plasma mass filter, with portions of the tandem mass filter broken away for clarity;

FIG. 2 is a sectional view of the as seen along line 2-2 in FIG. 1 showing the path of the jet of feed material in relation to the rotation of the plasma; and

FIG. 3 is an enlarged, representative view of a jet of feed material that has broken into droplets before reaching the target volume for vaporization.

### DESCRIPTION OF THE PREFERRED EMBODIMENTS

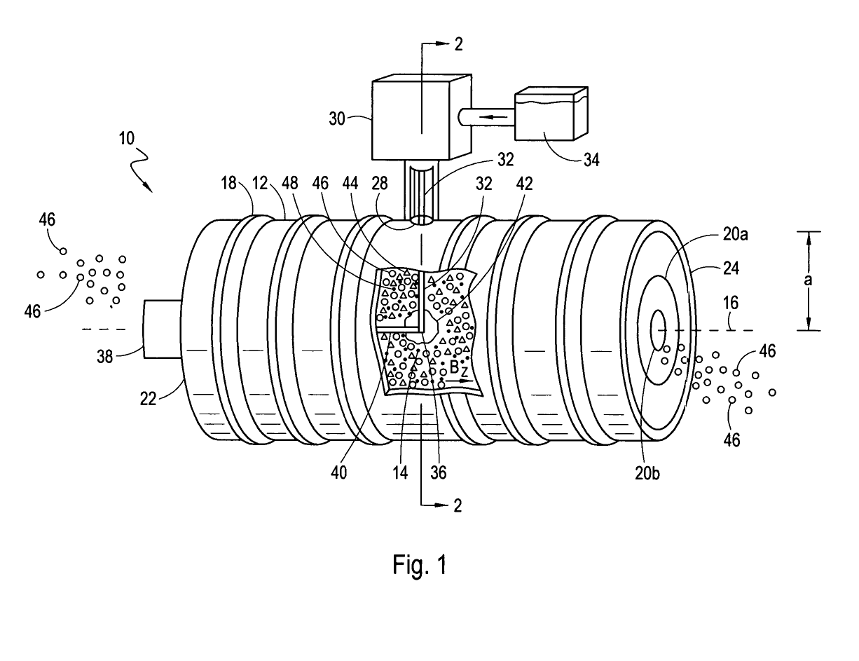

Referring to FIG. 1, a tandem plasma mass filter having an injector system in accordance with the present invention is shown and generally designated 10. As shown, the filter 10 includes a substantially cylindrical shaped wall 12 which surrounds a chamber 14, and defines a longitudinal axis 16. The actual dimensions of the chamber 14 are somewhat, but not entirely, a matter of design choice. Importantly, the radial distance “a” between the longitudinal axis 16 and the wall 12 is a parameter which will affect the operation of the filter 10, and as clearly indicated elsewhere herein, must be taken into account.

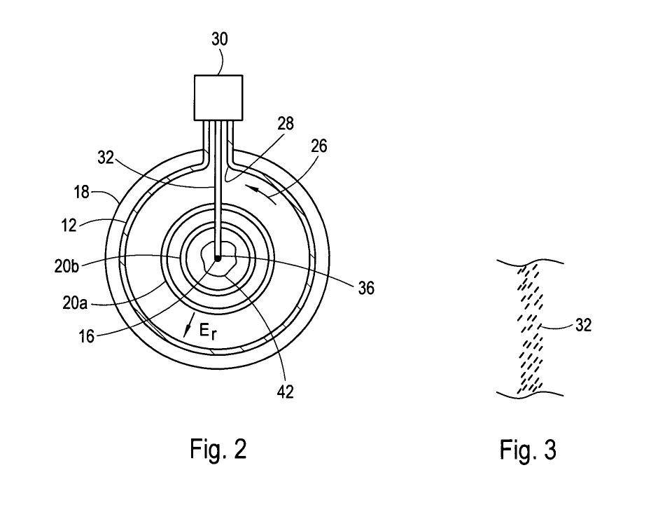

It is also shown in FIG. 1 that the filter 10 includes a plurality of magnetic coils 18 which are mounted on the outer surface of the wall 12 to surround the chamber 14. In a manner well known in the pertinent art, the coils 18 can be activated to create a magnetic field in the chamber 14 which has a component B_{z} that is directed substantially parallel to the longitudinal axis 16. Additionally, the filter 10 includes a plurality of voltage control rings 20, of which the voltage rings 20a and 20b are representative. As shown these voltage control rings 20 are located at one of the ends 22, 24 of the cylindrical shaped wall 12 and lie generally in a plane that is substantially perpendicular to the longitudinal axis 16. With this combination, a radially oriented electric field, Eᵣ, (shown in FIG. 2) can be generated. With cross reference to FIGS. 1 and 2, it is to be appreciated that a plasma in the chamber 14 will rotate azimuthally about the longitudinal axis 16 (azimuthal rotation direction shown by arrow 26) in the crossed electric Eᵣ, and magnetic B_{z}, fields.

Referring still with cross reference to FIGS. 1 and 2, it can be seen that the wall 12 of the filter 10 is formed with an inlet 28 that is positioned substantially midway between the ends 22, 24. In accordance with the present invention, the filter 10 also includes an injector 30, shown mounted to the outside of the wall 12 and oriented to deliver a fluid jet 32 of feed material 34 through the inlet 28 and into the chamber 14. In more detail, a fluidic feed material 34 is fed into the injector 30 which creates a fluid jet 32 having a predetermined velocity and radius. For the present invention, any injector 30 known in the pertinent art for creating a fluid jet 32 having a predetermined velocity and radius from a fluidic feed material 34, such as conventional pressure driven injectors, can be used.

To create the fluidic feed material 34, a multi-constituent material requiring separation can be dissolved or entrained as a powderized solid in a suitable fluidic carrier material. For example, the multi-constituent material can be dissolved in a solvent such as water, sodium hydroxide or a combination thereof. For the present invention, it is contemplated that the multi-constituent material may include metal oxides, metal nitrates or a combination thereof.

As further shown in FIGS. 1 and 2, the injector 30 is oriented to deliver a fluid jet 32 that is directed toward a target volume 36 in the plasma chamber 14. As explained further below, the target volume 36 is preferably located substantially on the longitudinal axis 16. As best seen in FIG. 2, the feed material 34 is injected into the chamber 14 along a path that is transverse to the azimuthally rotating plasma (rotation direction indicated by arrow 26) from the wall 12 to the target volume 36.

As indicated above, the injector 30 is capable of producing a fluid jet 32 having a predetermined velocity and radius. In accordance with the mathematics outlined above, the velocity and radius of the fluid jet 32 are selected and controlled to cause most of the vaporization of the feed material 34 to occur at the target volume 36 rather than near the wall 12 of the filter 10 where evaporation would result in a loss of feed material 34 from the plasma. Additionally, the velocity and radius of the fluid jet 32 are selected and controlled to minimize deflection of the jet 32 of feed material 34 by the rotating plasma. By minimizing the deflection of the jet 32 in this manner, the jet 32 can consistently reach the target volume 36, regardless of fluctuations in the rotational speed and density of the plasma. It is to be appreciated that several factors will influence the selection of the velocity and radius of the jet 32 to minimize transit vaporization, overshoot and deflection. These include the characteristics of the feed material 34, the density and rotational speed of the plasma in the chamber 14, and the size of the plasma chamber 14. It is further contemplated that surface tension may cause the jet 32 of feed material 34 to break up into droplets, as shown in FIG. 3, in the plasma chamber 14 before arriving at the target volume 36.

As described above, droplets of radius r₀, where:
r₀<<[4/3][M′/M][P/H]² [ω² R n n₀]⁻¹
will evaporate before leaving the plasma region. To vaporize larger droplets, the filter 10 can further include a source 38 for generating an energy beam 40, such as a laser or microwave beam, and directing the energy beam 40 toward the target volume 36, as shown in FIG. 1. Although the source 38 is shown positioned at the end 22 of the wall 12 and directing an energy beam 40 along the axis 16, it is to be appreciated that this configuration is merely exemplary and the position of the source 38 can be varied. Further, it is contemplated by the present invention that a heating device, such as a laser, or microwave energy source, can be directed into the plasma chamber 14 to generate the required energy beam 40 and direct the energy beam 40 to the target volume 36. For the filter 10, the source 38 has a suitable energy and beam width to vaporize the jet 32 of feed material 34 at the target volume 36 as the jet 32 of feed material 34 arrives at the target volume 36.

In another embodiment, the source 38 is configured to provide vibrational energy to the droplets at the injection point to induce controlled break-up of the droplets into smaller droplets inside the plasma. For a more detailed discussion concerning the use of vibration energy to break up the droplets, see “Formation of Sprays From Liquid Jets by a Superimposed Sequence of Nonaxial Disturbances,” by Y. Zimmels and S. Sadik, published in Applied Physics Letters, Volume 79, Number 27, on Dec. 31, 2001.

Referring now to FIG. 1, it is to be appreciated that upon vaporization of the jet 32 of feed material 34 at the target volume 36, a vapor cloud 42 of vaporized feed material 34 is created in the chamber 14. As shown, the vapor cloud 42 is roughly spherical in shape and is substantially centered on the longitudinal axis 16. Because the vapor cloud 42 is located on the longitudinal axis 16 rather than near the wall 12, neutrals of feed material 34 in the vapor cloud 42 will be dissociated and ionized by the rotating plasma in the plasma chamber 14 before a significant amount of feed material 34 is lost from the plasma (i.e. before neutrals from the vapor cloud 42 are centrifuged into the wall 12 by the rotating plasma).

Referring still to FIG. 1, it is to be appreciated that dissociation and ionization of the vapor cloud 42 produces a multi-species plasma from the feed material 34 in the plasma chamber 14. Specifically, as shown, the multi-species plasma includes ions having a relatively high mass to charge ratio (hereinafter high-mass ions 44, shown as triangles), ions having a relatively low mass to charge ratio (hereinafter low-mass ions 46, shown as circles), and electrons 48 (shown as dots). Once the feed material 34 has been converted into a multi-species plasma, the multi-species plasma can be separated into high-mass ions 44 and low-mass ions 46 in the crossed electric and magnetic fields. Specifically, the crossed electric and magnetic fields cause charged particles (i.e. ions) to move on helical paths about the longitudinal axis 16.

In operation, the voltage control rings 20a,b are energized to establish a parabolic voltage profile with a positive voltage, V_{ctr}, along the longitudinal axis 16 compared to the voltage at the wall 12 which will normally be a zero voltage. With these crossed electric and magnetic fields, the demarcation between low-mass ions 46 and high-mass ions 44 is a cut-off mass, M_{c}, which can be established by the expression:
M_{c}=ea²(B_{z})²/8V_{ctr}.

In the above expression, e is the ion charge, a is the radius of the chamber 14, B_{z} is the magnitude of the magnetic field, and V_{ctr} is the positive voltage which is established along the longitudinal axis 16. The quantities “a”, B_{z} and V_{ctr} can all be specifically designed or established for the operation of plasma mass filter 10.

Due to the configuration of the crossed electric and magnetic fields and, importantly, the positive voltage V_{ctr} along the longitudinal axis 16, the plasma mass filter 10 causes charged particles in the multi-species plasma to behave differently as they transit the chamber 14. Specifically, charged high-mass ions 44 (i.e. M>M_{c}) are not able to transit the chamber 14 and, instead, they are ejected into the wall 12. On the other hand, charged low-mass ions 46 (i.e. M<M_{c}) are confined in the chamber 14 during their transit through the chamber 14. Thus, the low-mass ions 46 exit the chamber 14 through the ends 22, 24 and are, thereby, effectively separated from the high-mass ions 44.

While the particular Injector for Plasma Mass Filter as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A system for injecting a feed material into a plasma chamber to convert the feed material into a plasma, said plasma chamber having a substantially cylindrical wall centered on an axis and containing a plasma having a substantially azimuthal rotation about said axis, said system comprising:
an injector for introducing a fluid jet of said feed material into said chamber at a predetermined velocity and with a preselected jet radius, with said injector positioned and oriented to direct said fluid jet from said wall, transversely through said rotating plasma to a target volume in said plasma chamber, said target volume being located substantially on said axis; and
a means for vaporizing said feed material at said target volume to create a plasma from said feed material.

2. A system as recited in claim 1 wherein said vaporizing means comprises a laser source for creating a laser beam to irradiate said feed material at said target volume.

3. A system as recited in claim 1 wherein said vaporizing means comprises a microwave source for creating a microwave beam to irradiate said feed material at said target volume.

4. A system as recited in claim 1 wherein the feed material includes a compound selected from the group consisting of a metal oxide and a metal nitrate.

5. A system as recited in claim 4 wherein said compound is dissolved in a solvent selected from the group consisting of water and sodium hydroxide.

6. A system as recited in claim 1 wherein said fluid jet of feed material arrives at said target location as droplets.

7. A system as recited in claim 6 wherein said droplets have a diameter less that approximately 60 μm.

8. A system as recited in claim 6 further comprising a means for producing vibrational energy to break up said droplets.

9. A plasma mass filter for separating a multi-constituent material into constituents, said plasma mass filter comprising:
a cylindrical shaped wall surrounding a plasma chamber and defining a longitudinal axis, said cylindrical shaped wall having a first end and a second end and being formed with at least one chamber inlet positioned therebetween;
means for generating a magnetic field in said chamber, said magnetic field being aligned substantially parallel to said longitudinal axis;
means for generating an electric field substantially perpendicular to said magnetic field to create crossed magnetic and electric fields, said electric field having a positive potential on said longitudinal axis and a substantially zero potential on said wall;
an injector for introducing a fluid jet of said multi-constituent material through said chamber inlet and into said chamber at a predetermined velocity and with a preselected jet radius, with said injector positioned and oriented to direct said fluid jet in a substantially radial direction from said wall to a target volume in said plasma chamber, said target volume being located substantially on said longitudinal axis; and
a means for vaporizing said multi-constituent material at said target volume to create a multi-species plasma having high-mass particles and low-mass particles in said chamber to interact with said crossed magnetic and electric fields for ejecting said high-mass particles into said wall and for confining said low-mass particles in said chamber during transit therethrough to separate said low-mass particles from said high-mass particles.

10. A filter as recited in claim 9 wherein said vaporizing means comprises a laser source for creating a laser beam to irradiate said multi-constituent material at said target volume.

11. A filter as recited in claim 9 wherein said vaporizing means comprises a microwave source for creating a microwave beam to irradiate said multi-constituent material at said target volume.

12. A filter as recited in claim 9 wherein said vaporizing means comprises a vibrational excitation source for injected droplets.

13. A filter as recited in claim 9 wherein said chamber inlet is positioned substantially midway between said first end of said wall and said second end of said wall.

14. A filter as recited in claim 9 wherein “e” is the charge of the particle, wherein said wall is at a distance “a” from said longitudinal axis, wherein said magnetic field has a magnitude “B_{z}” in a direction along said longitudinal axis, wherein said positive potential on said longitudinal axis has a value “V_{ctr}”, wherein said wall has a substantially zero potential, and wherein said low-mass particle has a mass less than M_{c}, where
M_{c}=ea²(B_{z})²/8V_{ctr}.

15. A filter as recited in claim 9 wherein said means for generating said magnetic field is a magnetic coil mounted on said wall.

16. A filter as recited in claim 9 wherein said means for generating said electric field is a plurality of conducting rings mounted to said first end of said wall and centered on said longitudinal axis at one end of said chamber.

17. A method for injecting a feed material into a plasma chamber to convert the feed material into a plasma, said plasma chamber having a substantially cylindrical wall centered on an axis and containing a plasma having a substantially azimuthal rotation about said axis, said method comprising the steps of:
selecting a target volume located substantially on said axis;
injecting a fluid jet of said feed material into said chamber at a predetermined velocity and with a preselected jet radius, wherein said fluid jet is oriented to deliver said feed material from said wall, transversely through said rotating plasma to said target volume in said plasma chamber; and
vaporizing said feed material at said target volume to create a plasma from said feed material.

18. A method as recited in claim 17 wherein said predetermined velocity and said preselected jet radius are selected to minimize evaporation of said fluid jet between said wall and said target volume.

19. A method as recited in claim 17 wherein said predetermined velocity and said preselected jet radius are selected to minimize deflection of said jet by said rotating plasma.

20. A method as recited in claim 17 wherein said fluid jet of said feed material arrives at said target location as droplets.

21. A method as recited in claim 17 further comprising the step of dissolving said feed material in a solvent selected from the group consisting of water and sodium hydroxide.

22. A method as recited in claim 17 wherein said vaporizing step is accomplished by irradiating said fluid jet of said feed material at said target volume with a laser beam.
